(19) United States
(12) Patent Application Publication
(10) Pub. No.: US 2026/0296892 A1
(43) Pub. Date: Oct. 1, 2026

(54) CONDUCTIVE DISPERSION AND PRODUCTION METHOD THEREFOR

(71) Applicant: Panasonic Intellectual Property Management Co., Ltd., Kadoma-shi, Osaka (JP)

(72) Inventors: Yuji Yokoyama, HYOGO KEN (JP); Kenya Hori, OSAKA FU (JP)

(73) Assignee: Panasonic Intellectual Property Management Co., Ltd., Kadoma-shi, Osaka (JP)

(21) Appl. No.: 19/478,529

(22) PCT Filed: Apr. 8, 2024
(86) PCT No.: PCT/JP2024/014275

§ 371 Date: Oct. 24, 2025

(30) Foreign Application Priority Data
Apr. 26, 2023 (JP) 2023-072686

(51) Int. Cl. C01B 32/174; H01M 4/62; H01M 10/0525

(52) U.S. Cl. CPC C01B 32/174; H01M 4/625; H01M 10/0525; C01B 2202/02; C01B 2202/22; C01B 2202/34; C01B 2202/36; C01P 2006/40

(57) ABSTRACT

A conductive dispersion includes a conductive carbon material, a liquid component, and a resin component dissolved in the liquid component. The conductive carbon material is dispersed in the liquid component. The conductive carbon material is in a fibrous form or in an aggregate form. The resin component includes a first component and a second component. The weight-average molecular weight Mw1 of the first component and the weight-average molecular weight Mw2 of the second component satisfy Mw1<Mw2, or the viscosity V1 of a first solution in which the first component is dissolved at a predetermined concentration in the liquid component and the viscosity V2 of a second solution in which the second component is dissolved at the predetermined concentration in the liquid component satisfy V1<V2.

### CROSS REFERENCE TO RELATED APPLICATION

The present disclosure claims priority with respect to the Japanese Patent Application No. 2023-072686 filed on Apr. 26, 2023, and the entire content of the patent application is incorporated herein by reference into the present specification.

### TECHNICAL FIELD

The present invention relates to a conductive dispersion and a method for producing the same.

### BACKGROUND ART

Patent Literature 1 proposes “a carbon nanotube dispersion liquid containing carbon nanotubes, carboxymethyl cellulose or a salt thereof, and water, in which the carboxymethyl cellulose or the salt thereof has a weight-average molecular weight of 10,000 to 100,000, and a degree of etherification of 0.5 to 0.9, and a value (X×Y) obtained by multiplying a complex elastic modulus X (Pa) by a phase angle Y (°) of the carbon nanotube dispersion liquid is 100 or more and 1,500 or less.”

Patent Literature 2 proposes “a conductive material paste composition for a secondary battery electrode, the conductive material paste including a fibrous carbon nanomaterial, a binder, and a solvent, in which the binder includes a first copolymer containing an alkylene structural unit and a nitrile group-containing monomer unit, and having a weight-average molecular weight of 170,000 or more and less than 1,500,000”, and “the binder further includes a second copolymer containing an alkylene structural unit and a nitrile group-containing monomer unit, and having a weight-average molecular weight of 10,000 or more and less than 170,000.”

### CITATION LIST

### Patent Literature

Patent Literature 1: Japanese Laid-Open Patent Publication No. 2021-175699
Patent Literature 2: International Publication WO2017/056488

### SUMMARY OF INVENTION

### Technical Problem

A conductive dispersion is required to have high dispersibility of a conductive carbon material, and high stability that enables the conductive carbon material to be kept dispersed without settling for a long time.

However, Patent Literature 1 uses a specific carboxymethyl cellulose or its salt alone. In this case, the control of the dispersibility and the stability by the physical properties of the carboxymethyl cellulose or its salt, usually, results in trade-off relationships where when one improves, the other deteriorates.

The copolymer containing an alkylene structural unit and a nitrile group-containing monomer unit of Patent Literature 2 is in a particulate state, and insoluble in a solvent. Therefore, settling of the fibrous carbon nanomaterial tends to occur, and the stability is difficult to improve.

### Solution to Problem

One aspect of the present disclosure relates to a conductive dispersion, including: a conductive carbon material; a liquid component; and a resin component dissolved in the liquid component, wherein the conductive carbon material is dispersed in the liquid component, the conductive carbon material is in a fibrous form or in an aggregate form, the resin component includes a first component and a second component, and a weight-average molecular weight Mw1 of the first component and a weight-average molecular weight Mw2 of the second component satisfy Mw1<Mw2.

Another aspect of the present disclosure relates to a conductive dispersion, including: a conductive carbon material; a liquid component; and a resin component dissolved in the liquid component, wherein the conductive carbon material is dispersed in the liquid component, the conductive carbon material is in a fibrous form or in an aggregate form, the resin component includes a first component and a second component, and a viscosity V1 of a first solution in which the first component is dissolved at a predetermined concentration in the liquid component and a viscosity V2 of a second solution in which the second component is dissolved at the predetermined concentration in the liquid component satisfy V1<V2.

Still another aspect of the present disclosure relates to a method for producing a conductive dispersion including a conductive carbon material, a liquid component, and a resin component dissolved in the liquid component, in which the resin component includes a first component and a second component, the conductive carbon material is in a fibrous form or in an aggregate form, and a weight-average molecular weight Mw1 of the first component and a weight-average molecular weight Mw2 of the second component satisfy Mw1<Mw2, the method including: (i) a step of dispersing the conductive carbon material and a part of the resin component in the liquid component, to obtain an intermediate dispersion, and (ii) a step of dispersing a remainder of the resin component in the intermediate dispersion, wherein the part of the resin component used in the step (i) contains the first component more than the second component, and the remainder of the resin component used in the step (ii) contains the second component more than the first component.

Yet another aspect of the present disclosure relates to a method for producing a conductive dispersion including a conductive carbon material, a liquid component, and a resin component dissolved in the liquid component, in which the resin component includes a first component and a second component, the conductive carbon material is in a fibrous form or in an aggregate form, and a viscosity V1 of a first solution in which the first component is dissolved at a predetermined concentration in the liquid component and a viscosity V2 of a second solution in which the second component is dissolved at the predetermined concentration in the liquid component satisfy V1<V2, the method including: (i) a step of dispersing the conductive carbon material and a part of the resin component in the liquid component, to obtain an intermediate dispersion, and (ii) a step of dispersing a remainder of the resin component in the intermediate dispersion, wherein the part of the resin component used in the step (i) contains the first component more than the second component, and the remainder of the resin component used in the step (ii) contains the second component more than the first component.

### Advantageous Effects of Invention

According to the present disclosure, it is possible to obtain a conductive dispersion that can achieve both high dispersibility and high stability.

While the novel features of the invention are set forth particularly in the appended claims, the invention, both as to organization and content, will be better understood and appreciated, along with other objects and features thereof, from the following detailed description taken in conjunction with the drawings.

### DESCRIPTION OF EMBODIMENTS

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components may be adopted. In the present specification, when referring to “a range of a numerical value A to a numerical value B,” the range includes the numerical value A and the numerical value B. When a plurality of materials are mentioned as examples, one kind of them may be selected and used singly, or two or more kinds of them may be used in combination.

A conductive dispersion according to the present disclosure (hereinafter sometimes referred to as a “dispersion (D)”) contains a conductive carbon material, a liquid component, and a resin component dissolved in the liquid component, and has fluidity. The dispersion (D) is a material used for production of an electrode for an electrochemical device. The electrode may be any kind of electrodes, including an electrode that exhibits capacity through a Faradaic reaction, an electrode that exhibits capacity through a non-Faradaic reaction, and an electrode having properties of both of them.

The electrochemical device may be a capacitor (condenser), and may be a secondary battery. The capacitor may be a lithium-ion capacitor, an electric double layer capacitor, and the like. The secondary battery may be a nonaqueous electrolyte secondary battery, such as lithium-ion secondary battery, lithium secondary battery (lithium-metal secondary battery), and all-solid-state secondary battery. The dispersion (D) is to be mixed with, for example, an electrode material for a nonaqueous electrolyte secondary battery. In that case, the dispersion (D) constitutes a part of the electrode material for a nonaqueous electrolyte secondary battery. Especially in the positive electrode for a nonaqueous electrolyte secondary battery, which contains a ceramic material as an essential component, the use of a conductive carbon material is often indispensable.

In the dispersion (D), the conductive carbon material is dispersed in a liquid component. The liquid component may be any component capable of dissolving the resin component and capable of dispersing the conductive carbon material.

The conductive carbon material is in a fibrous form or in an aggregate form. The conductive carbon material may be used singly, or in combination of two or more kinds.

Typical examples of the conductive carbon material in a fibrous form include carbon nanotubes (CNTs) and carbon nanofibers (CNFs).

The CNTs may be single-walled carbon nanotubes (SWCNTs), may be double-walled carbon nanotubes (DWCNTs), may be multi-walled carbon nanotubes (MWCNTs), and may be a mixture of the both. MWCNTs is a general term for carbon nanotubes with two or more walls. Examples of MWCNTs include DWCNTs, triple-walled CNTs, and CNTs with four or more walls.

Among CNTs, SWCNTs, even when contained in a small amount in an electrode, can significantly improve the conductivity of the electrode, which, however, is a difficult material that cannot be kept dispersed without settling for a long time in a liquid component. On the other hand, according to the present disclosure, it is possible to obtain a conductive dispersion containing SWCNTs as a conductive carbon material and having both high dispersibility and high stability. For example, 50 mass % or more of the conductive carbon material in the dispersion (D) may be SWCNTs.

The average diameter of the CNTs is not particularly limited, and may in a range of 1 nm to 50 nm. Note that, in the carbon nanotubes having an average diameter of 5 nm or less, SWCNTs is much contained. When N carbon nanotubes (e.g., 100≤N) are selected at random, 50% (0.5N) or more, or even 80% (0.8N) or more of the selected carbon nanotubes may individually have a diameter of 5 nm or less, and may individually have a diameter of 3 nm or less. The CNTs having a diameter of 3 nm or less may be regarded as SWCNTs.

The average length of the CNTs, although not particularly limited to, may be 0.5 μm or more, and may be 1 μm or more and 25 μm or less. When N carbon nanotubes (e.g., 100≤N) are selected at random, 50% (0.5N) or more, or even 80% (0.8N) or more of the selected carbon nanotubes may individually have a length of 1 μm or more, may individually have a length of 1 μm or more and 25 μm less, and may individually have a length of 1 μm or more and 20 μm or less.

CNFs is, for example, a kind of MWCNTs, and is produced as vapor-grown carbon fibers (VGCFs). CNFs is usually larger in diameter than CNTs, and at least partially has a graphitic structure.

The average diameter of the CNFs is, for example, 10 nm to 1000 nm, preferably 100 nm to 200 nm. The average length of the CNFs is, for example, 5 μm to 500 μm, preferably 50 μm to 100 μm.

The average diameter and the average length of the CNTs and the CNFs can be determined by image analysis using a scanning electron microscope (SEM). For example, the length can be determined by selecting a plurality of (e.g., about 100 to 1000) CNTs or CNFs at random, to measure the length and the diameter of them, and averaging the measured values.

The conductive carbon material in an aggregate form is an aggregated body of fine carbon particles, and may be amorphous carbon having a structure. A typical example of the conductive carbon material in an aggregate form is carbon black. Carbon black has a structure in which carbon particles with a primary particle diameter of, for example, 5 nm to 500 nm are linked together like a chain. The carbon black may be acetylene black, Ketjen black, channel black, furnace black, lamp black, thermal black, and the like.

The resin component includes a first component and a second component. The resin component acts as a dispersant for dispersing the conductive carbon material in the liquid component, and has a function to increase the viscosity of the dispersion (D). Increasing the viscosity of the dispersion (D) can suppress the aggregation and settling of the conductive carbon material. The resin component satisfies at least one of the following conditions (A) and (B). As long as at least one of the conditions (A) and (B) is satisfied, the first component and the second component may be the same kind of resins, or different kinds of resins.

### <Condition (A)>

A weight-average molecular weight Mw1 of the first component and a weight-average molecular weight Mw2 of the second component satisfy Mw1<Mw2.

### <Condition (B)>

A viscosity V1 of a first solution in which the first component is dissolved at a predetermined concentration in the liquid component and a viscosity V2 of a second solution in which the second component is dissolved at the same predetermined concentration in the liquid component satisfy V1<V2.

When the first component is used alone, many molecules of the first component will adsorb onto the conductive carbon material in the liquid component. The conductive carbon material is allowed to easily disperse, but tends to aggregate and settle over time. On the other hand, when the second component is used alone, few molecules of the second component will adsorb onto the conductive carbon material in the liquid component. The conductive carbon material is not allowed to easily disperse, but hardly aggregate and hardly settle. By using the first component and the second component in combination, high dispersibility of the conductive dispersion and high stability of the dispersion (D) can be both achieved.

The weight-average molecular weights of the first component and the second component may satisfy 5≤Mw2/Mw1, may satisfy 7≤Mw2/Mw1, may satisfy 20≤23Mw2/Mw1, and may satisfy 30≤Mw2/Mw1. The larger the Mw2/Mw1 ratio is, the higher the stability of the dispersion (D) becomes.

The weight-average molecular weight Mw1 of the first component is preferably, for example, 20,000 to 2,000,000. When the Mw1 is sufficiently small, the dispersibility of the first component itself in the liquid component is enhanced. In addition, the number of the molecules of the first component that will adsorb onto the conductive carbon material increases, and the dispersibility of the conductive carbon material is enhanced. On the other hand, in order to increase the viscosity of the liquid component to a certain level or higher and apply sufficient shear force to the conductive carbon material when dispersing the conductive carbon material, it is preferable to set the weight-average molecular weight Mw1 of the first component to be equal to or more than the above lower limit value.

The weight-average molecular weight Mw2 of the second component is preferably, for example, 50,000 to 10,000,000. When the Mw2 is sufficiently large, the floating state of the second component itself in the liquid component is stabilized, and the viscosity of the dispersion (D) is increased. This suppresses the aggregation and settling of the conductive carbon material, leading to improved stability of the dispersion (D). On the other hand, when the viscosity of the dispersion (D) is increased excessively, the ease of handling is reduced. It is therefore preferable to set the weight-average molecular weight Mw2 of the second component to be equal to or less than the above upper limit value.

The viscosity V1 of the first solution in which the first component is dissolved at a predetermined concentration (e.g., a content ratio of 1 mass %) in the liquid component and a viscosity V2 of the second solution in which the second component is dissolved at the same concentration in the liquid component may satisfy 5≤V2/V1, may satisfy 7≤V2/V1, may satisfy 100≤V2/V1, and may satisfy 500≤V2/V1. The larger the V2/V1 ratio is, the higher the stability of the dispersion (D) becomes. The viscosities V1 and V2 are measured at the same temperature, and may be measured at a temperature of, for example, 25° C. The viscosity may be measured using a B-type viscometer at a rotation speed of 20 rpm.

The viscosity V1 (1%/25° C.) at 25° C. of a solution of the liquid component in which the content ratio of the first component is 1 mass % is preferably 1 to 2,000 mPas. When the V1 (1%/25° C.) is sufficiently small, the dispersibility of the first component itself in the liquid component is enhanced. In addition, the number of the molecules of the first component that will adsorb onto the conductive carbon material increases, and the dispersibility of the conductive carbon material is enhanced. On the other hand, in order to increase the viscosity of the liquid component to a certain level or higher and apply sufficient shear force to the conductive carbon material when dispersing the conductive carbon material, it is preferable to set the V1 (1%/25° C.) to be equal to or more than the above lower limit value.

The viscosity V2 (1%/25° C.) at 25° C. of a solution of the liquid component in which the content ratio of the second component is 1 mass % is preferably, for example, 2 to 50,000 m·Pa. When the V2 (1%/25° C.) is sufficiently large, the floating state of the second component itself in the liquid component is stabilized, and the viscosity of the dispersion (D) is increased. This suppresses the aggregation and settling of the conductive carbon material, leading to improved stability of the dispersion (D). On the other hand, when the viscosity of the dispersion (D) is increased excessively, the ease of handling is reduced. It is therefore preferable to set the viscosity V2 (1%/25° C.) to be equal to or less than the above upper limit value.

The liquid component may be a dispersion medium for dispersing the electrode material, in the production of an electrode. Such a liquid component may be a polar solvent. Examples of the polar solvent include water, N-methyl-2-pyrrolidone (NMP), cyclohexanone, alcohols, and ethers. In particular, water or NMP is preferred. Eighty mass % or more of the liquid component may be a polar solvent. Eighty mass % or more of the liquid component may be water. Eighty mass % or more of the liquid component may be NMP.

When the liquid component contains a polar solvent, the first component and the second component are both preferably a water-soluble polymer. The polar solvent is a good solvent for the water-soluble polymer. The water-soluble polymer may be a polymer compound which is soluble in water and has a hydrophilic group in its backbone or side chain. The hydrophilic group that the water-soluble polymer has may be a polyoxyalkylene chain, a hydroxy group, a carboxyl group, an acid anhydride group, an amino group, a C2-3 alkylene oxide group, and the like.

Specific examples of the water-soluble polymer include polyalkylene glycol compounds, water-soluble polyamides, water-soluble polyimides, water-soluble acrylic resins (polyacrylic acid, etc.), polyvinyl alcohol, polyvinylpyrrolidone, and cellulose derivatives.

Among the water-soluble polymers, a cellulose derivative is preferred because it is inexpensive and easily soluble in water or NMP. Examples of the cellulose derivative include methyl cellulose, carboxymethyl cellulose (CMC), an ammonium salt of CMC, and an alkali metal salt of CMC. The alkali metal salt may be a sodium salt, a potassium salt, a lithium salt, and the like.

In the dispersion (D), the conductive carbon material and the resin component constitute aggregated particles, and the aggregated particles may be dispersed in the liquid component. The aggregated particles may be constituted of the conductive carbon material and the resin component entangled with each other.

The average particle diameter of the aggregated particles in the liquid component is preferably, for example, 0.1 μm or more and 50 μm or less. The average particle diameter of the aggregated particles may be measured with a particle diameter measuring apparatus using a dynamic light scattering method. The average particle diameter of the aggregated particles is the median diameter in a volumetric particle size distribution measured by a dynamic light scattering method.

A mass content ratio Mp1 of the first component in the aggregated particles and a mass content ratio Mp2 of the second component in the aggregated particles preferably satisfy Mp1>Mp2. By containing the first component, which is highly effective in enhancing the dispersibility of the conductive carbon material, more abundantly in the aggregated particles, the effect of enhancing the stability of the dispersion (D) is increased, while the dispersibility of the conductive carbon material or the aggregated particles is enhanced. The Mp1/Mp2 ratio preferably satisfies 1.1≤Mp1/Mp2, may satisfy 1.2≤23Mp1/Mp2, and may satisfy 1.5≤Mp1/Mp2.

The mass content ratio Mp1 of the first component and the mass content ratio Mp2 of the second component in the aggregated particles can be calculated by separating the aggregated particles from the dispersion (D), separating the resin component from the separated aggregated particles by centrifugation, and analyzing the resin component. The resin component contains the first and second components. Therefore, two main peaks are observed when a molecular weight distribution of the resin component is measured by gel-permeation chromatography. If the two main peaks are partially overlapped with each other, the two peaks are separated by waveform separation. From the integrated value of the areas of the two peaks, the Mp1/Mp2 ratio can be calculated. If three or more peaks are observed in the molecular weight distribution, the peak with the largest area and the peak with the second largest area are regarded as one and the other of the first and second components.

A mass content ratio Ms1 of the first component and a mass content ratio Ms2 of the second component in the liquid component excluding the aggregated particles may satisfy Ms1<Ms2. By containing the second component, which is highly effective in enhancing the stability of the dispersion (D), more abundantly than the first component in the liquid component, the stability of the dispersion (D) is further improved. The Ms2/Ms1 ratio preferably satisfies 1.1≤Ms2/Ms1, may satisfy 1.2≤Ms2/Ms1, and may satisfy 1.5≤23Ms2/Ms1.

The amount of the resin component relative to 100 parts by mass of the conductive carbon material contained in the dispersion (D) is preferably, for example, 10 parts by mass or more and 1000 parts by mass or less. In particular, when the conductive carbon material is CNTs, the amount of the resin component relative to 100 parts by mass of the CNTs is preferably, for example, 50 to 1000 parts by mass. When the conductive carbon material is carbon black, the amount of the resin component relative to 100 parts by mass of the carbon black is preferably, for example, 10 to 500 parts by mass.

The more the amount of the resin component is increased within the above range, the more the first component can be adsorbed onto the conductive carbon material. Thus, the dispersibility of the conductive carbon material can be improved, and the stability of the dispersion (D) obtained by the action of the second component can also be improved. Furthermore, by setting the amount of the resin component to be equal to or less than the upper limit value of the above range, it becomes easy to increase the amount of the conductive carbon material contained in the electrode while restricting the amount of the resin component contained in the electrode. This increases the degree of freedom in the blending amount of the dispersion (D) into the electrode material.

The amount of the resin component relative to 100 parts by mass of the conductive carbon material can be calculated by separating the aggregated particles from the dispersion (D), separating the resin component and the conductive carbon material from the separated aggregated particles by centrifugation or other techniques, and then, removing the liquid component by drying or other techniques from the residual liquid from which the aggregated particles have been separated, to separate the resin component, and totaling the amounts of the resin component separated from the aggregated particles and the resin component separated from the residual liquid.

Furthermore, by analyzing the separated resin component, the content ratio C1 of the first component and the content ratio C2 of the second component in the dispersion (D) can be calculated. The resin component contains the first and second components. Therefore, two main peaks are observed when a molecular weight distribution of the resin component is measured. If the two main peaks are partially overlapped with each other, the two peaks are separated by waveform separation. From the integrated values of the areas of the two peaks and a calibration curve prepared in advance, the C1, the C2, and the C1/C2 ratio can be calculated. If three or more peaks are observed in the molecular weight distribution, the peak with the largest area and the peak with the second largest area are regarded as one and the other of the first and second components.

The content ratio C1 of the first component is preferably, for example, 0.2 mass % or more and 5 mass % or less. The more the amount of the first component is increased within the above range, the more the first component can be adsorbed onto the conductive carbon material. Thus, the dispersibility of the conductive carbon material can be improved. Furthermore, by setting the amount of the first component to be equal to or less than the upper limit value of the above range, it becomes easy to increase the amount of the conductive carbon material contained in the electrode while restricting the amount of the resin component contained in the electrode.

The content ratio C2 of the second component is preferably, for example, 0.05 mass % or more and 10 mass % or less. The more the amount of the second component is increased within the above range, the more the stability of the dispersion (D) can be improved.

The C1/C2 ratio is, for example, 40 or less, and is preferably 1 or more. The larger the C1/C2 ratio is, the more the stability of the dispersion (D) can be improved.

Furthermore, from the viewpoint of enhancing the dispersibility of the conductive carbon material or aggregated particles while improving the stability of the dispersion (D), it is preferable to contain the first component, which is highly effective in enhancing the dispersibility of the conductive carbon material, relatively more abundantly in the aggregated particles than in the liquid component. That is, it is preferable to satisfy C1/C2<Mp1/Mp2. In that case, C1/C2>Ms1/Ms2 is also satisfied at the same time. Furthermore, 1.1≤(Mp1/Mp2)/(C1/C2) may be satisfied, or 1.1≤(Mp1/Mp2)/(C1/C2) may be satisfied. Moreover, 1.1≤(C1/C2)/(Ms1/Ms2) may be satisfied, or 1.1≤(C1/C2)/(Ms1/Ms2) may be satisfied.

The viscosity Vd (25° C.) of the dispersion (D) at 25° C. is preferably 100 to 10,000 mPa·s. When the viscosity Vd (25° C.) is within the above range, the dispersion (D) is highly stabile, and in blending it into an electrode material, can be highly dispersed in the electrode material.

### <Method for Producing Dispersion (D)>

A method for producing the dispersion (D) includes (i) dispersing the conductive carbon material and a part of the resin component in the liquid component, to obtain an intermediate dispersion, and (ii) dispersing a remainder of the resin component in the intermediate dispersion. In the step (i), the part of the resin component may be dispersed all at once in the liquid component, or may be dispersed dividedly in several times. Likewise, in the step (ii), the remainer of the resin component may be dispersed all at once in the intermediate dispersion, or may be dispersed dividedly in several times. The liquid component may be blended all at once with the conductive carbon material in the step (i), or the liquid component may be blended dividedly in the step (i) and the step (ii).

The part of the resin component used in the step (i) contains the first component more than the second component. The step (i) is mainly a step for allowing the first component to be adsorbed onto the conductive carbon material. In the step (i), it is desirable that the second component is used in a smallest possible amount, or is not used, so as not to inhibit contacting between the first component and the conductive carbon material. Ninety mass % or more of the part of the resin component used in the step (i) may be the first component. That is, the amount of the first component used in the step (i) relative to the total amount of the first component and the second component may be 90 mass % or more, may be 95 mass % or more, and may be 100%. The liquid component may be blended all at once with the conductive carbon material in the step (i), or the liquid component may be blended dividedly in the step (i) and the step (ii).

The remainder of the resin component used in the step (ii) contains the second component more than the first component. The step (ii) is a step for dissolving the second component in the intermediate dispersion, to obtain a dispersion (D) having a higher viscosity than the intermediate dispersion, and having reduced fluidity. In the step (ii), it is desirable that the first component is used in a smallest possible amount, or is not used, so as not to excessively increase the content ratio of the resin component in the dispersion (D). Ninety mass % or more of the remainder of the resin component used in the step (ii) may be the second component. That is, the amount of the second component used in the step (ii) relative to the total amount of the first component and the second component may be 90 mass % or more, may be 95 mass % or more, and may be 100%.

### (Supplementary Notes)

The above description of embodiments discloses the following techniques.

### (Technique 1)

A conductive dispersion, comprising:
a conductive carbon material; a liquid component; and a resin component dissolved in the liquid component, wherein
the conductive carbon material is dispersed in the liquid component,
the conductive carbon material is in a fibrous form or in an aggregate form,
the resin component includes a first component and a second component, and
a weight-average molecular weight Mw1 of the first component and a weight-average molecular weight Mw2 of the second component satisfy Mw1<Mw2.

### (Technique 2)

A conductive dispersion, comprising:
a conductive carbon material; a liquid component; and a resin component dissolved in the liquid component, wherein
the conductive carbon material is dispersed in the liquid component,
the conductive carbon material is in a fibrous form or in an aggregate form,
the resin component includes a first component and a second component, and
a viscosity V1 of a first solution in which the first component is dissolved at a predetermined concentration in the liquid component and a viscosity V2 of a second solution in which the second component is dissolved at the predetermined concentration in the liquid component satisfy V1<V2.

### (Technique 3)

The conductive dispersion according to technique 1, wherein 5≤Mw2/Mw1 is satisfied.

### (Technique 4)

The conductive dispersion according to technique 2, wherein 5≤V2/V1 is satisfied.

### (Technique 5)

The conductive dispersion according to any one of techniques 1 to 4, wherein
the liquid component contains a polar solvent, and
the first component and the second component are both a water-soluble polymer.

### (Technique 6)

The conductive dispersion according to technique 5, wherein the water-soluble polymer is a cellulose derivative.

### (Technique 7)

The conductive dispersion according to any one of techniques 1 to 6, wherein the conductive carbon material is at least one selected from the group consisting of carbon nanotubes (CNTs), carbon nanofibers (CNFs), and carbon black (CB).

### (Technique 8)

The conductive dispersion according to any one of techniques 1 to 7, wherein an amount of the resin component relative to 100 parts by mass of the conductive carbon material is 10 parts by mass or more and 1000 parts by mass or less.

### (Technique 9)

The conductive dispersion according to any one of techniques 1 to 8, wherein a content ratio C1 of the first component is 0.2 mass % or more and 5 mass % or less.

### (Technique 10)

The conductive dispersion according to any one of techniques 1 to 9, wherein a content ratio C2 of the second component is 0.05 mass % or more.

### (Technique 11)

The conductive dispersion according to any one of techniques 1 to 10, wherein a ratio C1/C2 is 40 or less.

### (Technique 12)

The conductive dispersion according to any one of techniques 1 to 11, wherein
the conductive carbon material and the resin component constitute aggregated particles, and
the aggregated particles are dispersed in the liquid component.

### (Technique 13)

The conductive dispersion according to technique 12, wherein an average particle diameter of the aggregated particles in the liquid component is 0.1 μm or more and 50 μm or less.

### (Technique 14)

The conductive dispersion according to technique 12 or 13, wherein a mass content ratio Mp1 of the first component in the aggregated particles and a mass content ratio Mp2 of the second component in the aggregated particles satisfy C1/C2<Mp1/Mp2.

### (Technique 15)

The conductive dispersion according to any one of techniques 12 to 14, wherein a mass content ratio Ms1 of the first component and a mass content ratio Ms2 of the second component in the liquid component excluding the aggregated particles satisfy C1/C2>Ms1/Ms2.

### (Technique 16)

The conductive dispersion according to any one of techniques 1 to 15, which is to be mixed with an electrode material for a lithium-ion secondary battery.

### (Technique 17)

A method for producing a conductive dispersion including a conductive carbon material, a liquid component, and a resin component dissolved in the liquid component, in which
the resin component includes a first component and a second component,
the conductive carbon material is in a fibrous form or in an aggregate form, and
a weight-average molecular weight Mw1 of the first component and a weight-average molecular weight Mw2 of the second component satisfy Mw1<Mw2,
the method comprising:
(i) a step of dispersing the conductive carbon material and a part of the resin component in the liquid component, to obtain an intermediate dispersion, and
(ii) a step of dispersing a remainder of the resin component in the intermediate dispersion, wherein
the part of the resin component used in the step (i) contains the first component more than the second component, and
the remainder of the resin component used in the step (ii) contains the second component more than the first component.

### (Technique 18)

A method for producing a conductive dispersion including a conductive carbon material, a liquid component, and a resin component dissolved in the liquid component, in which
the resin component includes a first component and a second component,
the conductive carbon material is in a fibrous form or in an aggregate form, and
a viscosity V1 of a first solution in which the first component is dissolved at a predetermined concentration in the liquid component and a viscosity V2 of a second solution in which the second component is dissolved at the predetermined concentration in the liquid component satisfy V1<V2,
the method comprising:
(i) a step of dispersing the conductive carbon material and a part of the resin component in the liquid component, to obtain an intermediate dispersion, and
(ii) a step of dispersing a remainder of the resin component in the intermediate dispersion, wherein
the part of the resin component used in the step (i) contains the first component more than the second component, and
the remainder of the resin component used in the step (ii) contains the second component more than the first component.

### (Technique 19)

The method for producing a conductive dispersion according to technique 17 or 18, wherein 90 mass % or more of the part of the resin component used in the step (i) is the first component.

### EXAMPLES

The conductive dispersion according to the present disclosure will be more specifically described below with reference to Examples and Comparative Examples. The present disclosure, however, is not limited to the following Examples.

### Example 1

### Step (i)

An intermediate dispersion was obtained by mixing 100 parts by mass of CNTs serving as the conductive carbon material, 100 parts by mass of a first CMC (Na salt of CMC) serving as the first component of the resin component, and 9800 parts by mass of water serving as the liquid component, and subjecting the mixture to a dispersion treatment 10 times using a high-pressure homogenizer.

The weight-average molecular weight Mw1 of the first CMC as measured by gel-permeation chromatography (GPC method) was 70,000, and the viscosity V1 of a first solution containing 1 mass % of the first CMC was 2 mPa·s at 25° C.

The CNTs had an average diameter of 1.4 nm, and an average length of 1 μm, and as a whole, was substantially SWCNTs.

### Step (ii)

Next, 100 parts by mass of a second CMC (Na salt of CMC) was added to the intermediate dispersion, and water was added thereto as necessary to adjust the concentration of the CNTs. A dispersion (D1) was thus obtained.

The weight-average molecular weight Mw2 of the second CMC as measured by GPC method was 3,000,000, and the viscosity V2 of a second solution containing 1 mass % of the second CMC was 2000 mPa·s at 25° C. Therefore, Mw2/Mw1=43, and V2/V1=1000.

The amount of the resin component (total amount of the first CMCs and the second CMCs) relative to 100 parts by mass of the CNTs was 200 parts by mass, and the content ratio of the CNTs in the dispersion (D) was 1.0 mass %. The content ratio C1 of the first CMC was 1.0 mass %, and the content ratio C2 of the second CMCs was 1.0 mass %. The C1/C2 ratio was 1.

TABLE 1

| | | | | | evaluation | |
|---|---|---|---|---|---|---|
| | first CMC | | second CMC | | resistance | |
| | | parts by | | parts by | to settling | viscosity |
| | Mw1 | mass | Mw2 | mass | (%) | (mPa · s) |
| CD1 | 70,000 | 100 | — | — | 69 | 100 |
| CD2 | 200,000 | 100 | — | — | 68 | 300 |
| CD3 | 3,000,000 | 100 | — | — | 66 | 500 |
| CD4 | 70,000 | 100 | 60,000 | 100 | 67 | 100 |
| CD5 | 200,000 | 100 | 80,000 | 100 | 69 | 350 |
| D1 | 70,000 | 100 | 3,000,000 | 100 | 84 | 500 |
| D2 | 70,000 | 100 | 1,750,000 | 100 | 75 | 300 |
| D3 | 70,000 | 100 | 450,000 | 100 | 74 | 200 |
| D4 | 70,000 | 100 | 80,000 | 100 | 72 | 150 |
| D5 | 70,000 | 100 | 3,000,000 | 20 | 70 | 180 |
| D6 | 70,000 | 100 | 3,000,000 | 25 | 74 | 200 |
| D7 | 70,000 | 100 | 1,750,000 | 25 | 73 | 190 |
| D8 | 70,000 | 100 | 450,000 | 40 | 72 | 150 |
| D9 | 200,000 | 100 | 3,000,000 | 100 | 80 | 700 |
| D10 | 200,000 | 100 | 450,000 | 100 | 75 | 400 |

### [Evaluation]

### (Stability of Dispersion (D))

The dispersion (D1) was left to stand for 10 days, to measure the solids content of the supernatant, which was used as an index of the degree of settling. The resistance to settling was defined by the following equation. The higher the numerical value is, the higher the stability is.

Resistance to settling (%)=100×(Solids content of supernatant)/Solids content of dispersion (D)

### (Viscosity of Dispersion (D))

The viscosity of the dispersion (D1) at 25° C. was measured using a B-type viscometer at a rotation speed of 20 rpm, which was 500 mPa/s.

### (Average Particle Diameter of Aggregated Particles)

The average particle diameter of the aggregated particles contained in the resultant dispersion (D1) was measured using a laser diffraction-type particle size distribution analyzer (e.g., MT3000II available from Microtrac Inc.). The result found that the median diameter in the volumetric particle size distribution was 10 μm, confirming that the aggregated particles were small and had high dispersibility.

### Comparative Example 1

A dispersion (CD1) was obtained by mixing 100 parts by mass of CNTs serving as the conductive carbon material, 100 parts by mass of the first CMC serving as the first component of the resin component, and 9800 parts by mass of water serving as the liquid component, and subjecting the mixture to a dispersion treatment 10 times using a high-pressure homogenizer. The average particle diameter of the aggregated particles contained in the resultant dispersion (CD1) was measured in the same manner as in Example 1. The result found that the median diameter in the volumetric particle size distribution was 10 μm, confirming that the aggregated particles were small and had high dispersibility. On the other hand, the evaluation on the stability of the dispersion (CD1) found that the resistance to settling was 69%, and the stability was insufficient. The viscosity of the dispersion (CD1) was 100 mPa/s.

### Comparative Example 2

A dispersion (CD2) was obtained in the same manner as in Comparative Example 1, except that the weight-average molecular weight of the first CMC was changed to 200,000. The average particle diameter of the aggregated particles contained in the resultant dispersion (CD2) was measured in the same manner as in Example 1. The result found that the median diameter in the volumetric particle size distribution was 15 μm, confirming that the aggregated particles were small and had high dispersibility. On the other hand, the evaluation on the stability of the dispersion (CD2) found that the resistance to settling was 68%, and the stability was insufficient. The viscosity of the dispersion (CD1) was 300 mPa/s.

### Comparative Example 3

A dispersion (CD3) was prepared in the same manner as in Comparative Example 1, except that the weight-average molecular weight of the first CMC was changed to 3,000,000. The average particle diameter of the aggregated particles contained in the resultant dispersion (CD3) was measured in the same manner as in Example 1. The result found that the median diameter in the volumetric particle size distribution was 30 μm, confirming that the aggregated particles were large and had low dispersibility. On the other hand, the evaluation on the stability of the dispersion (CD3) found that the resistance to settling was 66%, and the stability was also insufficient. The viscosity of the dispersion (CD1) was 500 mPa/s.

### Examples 2 to 10, Comparative Examples 4 and 5

Dispersions (D2 to D10, CD4, and CD5) were prepared in the same manner as in Example 1, except that the weight-average molecular weights and the blended amounts of the first CMC and the second CMC were changed as shown in Table 1, and the stability (resistance to settling) and the viscosity of each dispersion were measured. The results are shown in Table 1.

Comparative Examples 1 to 3 differed from each other in the weight-average molecular weight of the first CMC used in the CNT dispersion treatment. When the weight-average molecular weight was small, since a larger number of molecules could adsorb onto the CNTs, dispersion was facilitated, resulting in a small size of aggregated particles of CNTs after dispersion. On the other hand, the viscosity of the dispersion (CD) decreased, resulting in a low resistance to settling. When the first CMC having a high weight-average molecular weight was used, although the viscosity of the dispersion (CD) increased, the size of the aggregated particles of CNTs increased, resulting in a low resistance to settling.

On the other hand, as shown in each Example, when the second CMC having a high weight-average molecular weight was added to the intermediate dispersion after the CNT dispersion treatment, aggregation and settling were suppressed due to the effect of the increased viscosity of the dispersion (D) and the steric hindrance effect of inhibiting contacting between the CNTs by the second CMC. However, when the second CMC having a weight-average molecular weight similar to that of the first CMC was added, the effect of suppressing aggregation and settling was small. Furthermore, the larger the amount of the second CMC was, the greater the effect of suppressing aggregation and settling was. Furthermore, even though the weight-average molecular weight of the first CMC was quite high, when the weight-average molecular weight of the second CMC was sufficiently high, the effect of suppressing aggregation and settling was obtained.

### INDUSTRIAL APPLICABILITY

The conductive dispersion according to the present disclosure can be used to improve the conductivity of an electrode (esp. positive electrode) for an electrochemical device (esp. lithium secondary battery).

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A conductive dispersion, comprising:
a conductive carbon material; a liquid component; and a resin component dissolved in the liquid component, wherein
the conductive carbon material is dispersed in the liquid component,
the conductive carbon material is in a fibrous form or in an aggregate form,
the resin component includes a first component and a second component, and
a weight-average molecular weight Mw1 of the first component and a weight-average molecular weight Mw2 of the second component satisfy Mw1<Mw2, or
a viscosity V1 of a first solution in which the first component is dissolved at a predetermined concentration in the liquid component and a viscosity V2 of a second solution in which the second component is dissolved at the predetermined concentration in the liquid component satisfy V1<V2.

2. (canceled)

3. The conductive dispersion according to claim 1, wherein 5≤Mw2/Mw1 is satisfied.

4. The conductive dispersion according to claim 1, wherein 5≤V2/V1 is satisfied.

5. The conductive dispersion according to claim 1, wherein
the liquid component contains a polar solvent, and
the first component and the second component are both a water-soluble polymer.

6. The conductive dispersion according to claim 5, wherein the water-soluble polymer is a cellulose derivative.

7. The conductive dispersion according to claim 1, wherein the conductive carbon material is at least one selected from the group consisting of carbon nanotubes (CNTs), carbon nanofibers (CNFs), and carbon black (CB).

8. The conductive dispersion according to claim 1, wherein an amount of the resin component relative to 100 parts by mass of the conductive carbon material is 10 parts by mass or more and 1000 parts by mass or less.

9. The conductive dispersion according to claim 1, wherein a content ratio C1 of the first component is 0.2 mass % or more and 5 mass % or less.

10. The conductive dispersion according to claim 9, wherein a content ratio C2 of the second component is 0.05 mass % or more.

11. The conductive dispersion according to claim 1, wherein a ratio C1/C2 is 40 or less.

12. The conductive dispersion according to claim 1, wherein
the conductive carbon material and the resin component constitute aggregated particles, and
the aggregated particles are dispersed in the liquid component.

13. The conductive dispersion according to claim 12, wherein an average particle diameter of the aggregated particles in the liquid component is 0.1 μm or more and 50 μm or less.

14. The conductive dispersion according to claim 12, wherein a mass content ratio Mp1 of the first component in the aggregated particles and a mass content ratio Mp2 of the second component in the aggregated particles satisfy C1/C2<Mp1/Mp2.

15. The conductive dispersion according to claim 12, wherein a mass content ratio Ms1 of the first component and a mass content ratio Ms2 of the second component in the liquid component excluding the aggregated particles satisfy C1/C2>Ms1/Ms2.

16. The conductive dispersion according to claim 1, which is to be mixed with an electrode material for a lithium-ion secondary battery.

17. A method for producing a conductive dispersion including a conductive carbon material, a liquid component, and a resin component dissolved in the liquid component, in which
the resin component includes a first component and a second component,
the conductive carbon material is in a fibrous form or in an aggregate form, and
a weight-average molecular weight Mw1 of the first component and a weight-average molecular weight Mw2 of the second component satisfy Mw1<Mw2,
the method comprising:
(i) a step of dispersing the conductive carbon material and a part of the resin component in the liquid component, to obtain an intermediate dispersion, and
(ii) a step of dispersing a remainder of the resin component in the intermediate dispersion, wherein
the part of the resin component used in the step (i) contains the first component more than the second component, and
the remainder of the resin component used in the step (ii) contains the second component more than the first component.

18. A method for producing a conductive dispersion including a conductive carbon material, a liquid component, and a resin component dissolved in the liquid component, in which
the resin component includes a first component and a second component,
the conductive carbon material is in a fibrous form or in an aggregate form, and
a viscosity V1 of a first solution in which the first component is dissolved at a predetermined concentration in the liquid component and a viscosity V2 of a second solution in which the second component is dissolved at the predetermined concentration in the liquid component satisfy V1<V2,
the method comprising:
(i) a step of dispersing the conductive carbon material and a part of the resin component in the liquid component, to obtain an intermediate dispersion, and
(ii) a step of dispersing a remainder of the resin component in the intermediate dispersion, wherein
the part of the resin component used in the step (i) contains the first component more than the second component, and
the remainder of the resin component used in the step (ii) contains the second component more than the first component.

19. The method for producing a conductive dispersion according to claim 17, wherein 90 mass % or more of the part of the resin component used in the step (i) is the first component.

20. The method for producing a conductive dispersion according to claim 18, wherein 90 mass % or more of the part of the resin component used in the step (i) is the first component.
